(19) United States
(12) Patent Application Publication
(10) Pub. No.: US 2013/0191732 A1
(43) Pub. Date: Jul. 25, 2013

(54) Fixed Format Document Conversion Engine

(71) Applicants: Milos Lazarevic, Belgrade (RS); Milos Raskovic, Belgrade (RS); Aljosa Obuljen, Belgrade (RS); Milan Sesum, Belgrade (RS); Dusan Radovanovic, Belgrade (RS); Aleksandar Tomic, Belgrade (RS); Dragan Slaveski, Belgrade (RS); Marija Antic, Belgrade (RS)

(72) Inventors: Milos Lazarevic, Belgrade (RS); Milos Raskovic, Belgrade (RS); Aljosa Obuljen, Belgrade (RS); Milan Sesum, Belgrade (RS); Dusan Radovanovic, Belgrade (RS); Aleksandar Tomic, Belgrade (RS); Dragan Slaveski, Belgrade (RS); Marija Antic, Belgrade (RS)

(73) Assignee: MICROSOFT CORPORATION, Redmond, WA (US)

(21) Appl. No.: 13/521,378

(22) PCT Filed: Jan. 23, 2012
(86) PCT No.: PCT/EP12/00288

§ 371 Date: Jul. 10, 2012

(30) Foreign Application Priority Data
Jan. 23, 2012 (EP) PCT/EP2012/000288

(51) Int. Cl. G06F 17/00

(52) U.S. Cl. 715/249

(57) ABSTRACT

A fixed format document conversion engine and associated method for converting a fixed format document into a flow format document. The fixed format document conversion engine includes a sequence of layout analysis engines and semantic analysis engines to analyzes the base physical layout information obtained from the fixed format document to enrich, modify, and classify the physical layout information into progressively more advanced physical layout information and, ultimately, semantic layout information. The semantic layout information is mapped and serialized into a selected flow format document with a high level of flowability.

### BACKGROUND

Flow format documents and fixed format documents are widely used and have different purposes. Flow format documents organize a document using complex logical formatting structures such as sections, paragraphs, columns, and tables. As a result, flow format documents offer flexibility and easy modification making them suitable for tasks involving documents that are frequently updated or subject to significant editing. In contrast, fixed format documents organize a document using basic physical layout elements such as text runs, paths, and images to preserve the appearance of the original. Fixed format documents offer consistent and precise format layout making them suitable for tasks involving documents that are not frequently or extensively changed or where uniformity is desired. Examples of such tasks include document archival, high-quality reproduction, and source files for commercial publishing and printing. Fixed format documents are often created from flow format source documents. Fixed format documents also include digital reproductions (e.g., scans and photos) of physical (i.e., paper) documents.

In situations where editing of a fixed format document is desired but the flow format source document is not available, the fixed format document must be converted into a flow format document. Conversion involves parsing the fixed format document and transforming the basic physical layout elements from the fixed format document into the more complex logical elements used in a flow format document. Existing document converters faced with complex elements, such as borderless tables, resort to base techniques designed to preserve the visual fidelity of the layout (e.g., text frames, line spacing, and character spacing) at the expense of the flowability of the output document. The result is a limited flow format document that requires the user to perform substantial manual reconstruction to have a truly useful flow format document. It is with respect to these and other considerations that the present invention has been made.

### BRIEF SUMMARY

The following Brief Summary is provided to introduce a selection of concepts in a simplified form that are further described below in the Detailed Description. This Brief Summary is not intended to identify key features or essential features of the claimed subject matter, nor is it intended to be used to limit the scope of the claimed subject matter.

The fixed format document conversion engine includes a layout analysis engine and a semantic analysis engine. The layout analysis engine includes a number of detection engines operating in a dependency based sequence.

In one embodiment, the operational flow of the fixed format document conversion engine includes executing the following detection and/or reconstruction engines and operations in substantially the following order: the parser, the pattern matching engine, the formula detection engine, the text box detection engine, the layout analysis engine, the cross-region paragraph reconstruction engine, the section reconstruction engine, the style reconstruction engine, the heading reconstruction engine, the table of contents reconstruction engine, and the list reconstruction engine. The operational flow of the layout analysis engine includes executing the following detection and/or reconstruction engines and operations in substantially the following order: a whitespace detection operation, the vector graphic classification engine, another whitespace detection operation, the region detection engine, the line detection engine, the words-per-line detection engine, a basic graphic aggregation expansion operation, a region post-processing operation, the subscript/superscript detection engine, the borderless table detection engine, the page column detection engine, the in-region paragraph detection engine, the footnote/endnote detection engine, and a page margin detection engine.

Working together and in sequence, the detection engines in the layout analysis engine and the reconstruction engines in the semantic analysis engine analyze the base physical layout information obtained from the fixed format document to enrich, modify, and classify the physical layout information into progressively more advanced physical layout information and, ultimately, semantic layout information. The semantic layout information is mapped and serialized into a selected flow format document with a high level of flowability.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

Further features, aspects, and advantages will become better understood by reference to the following detailed description, appended claims, and accompanying figures, wherein elements are not to scale so as to more clearly show the details, wherein like reference numbers indicate like elements throughout the several views, and wherein:

FIG. 1 illustrates a system including the fixed format document conversion engine;

FIG. 2 is a block diagram showing the operational flow of one embodiment of the document processor;

FIGS. 3A-3B form a single block diagram showing the dependencies of the various engines that are part of the fixed format document conversion engine;

FIG. 4 illustrates a flow diagram showing the functions performed by the fixed format document conversion engine;

FIGS. 5A-C form a single flow diagram showing one embodiment of the functions performed by the layout analysis engine of the fixed format document conversion engine;

FIG. 6 illustrates a tablet computing device executing one embodiment of the fixed format document conversion engine;

FIG. 7 is a simplified block diagram of an exemplary computing device suitable for practicing embodiments of the fixed format document conversion engine;

FIG. 8A illustrates one embodiment of a mobile computing device executing one embodiment of the fixed format document conversion engine;

FIG. 8B is a simplified block diagram of an exemplary mobile computing device suitable for practicing embodiments of the fixed format document conversion engine; and

FIG. 9 is a simplified block diagram of an exemplary distributed computing system suitable for practicing embodiments of the fixed format document conversion engine.

### DETAILED DESCRIPTION

A fixed format document conversion engine and associated method for converting a fixed format document into a flow format document is described herein and illustrated in the accompanying figures. The fixed format document conversion engine includes a sequence of layout analysis engines and semantic analysis engines to analyze the base physical layout information obtained from the fixed format document to enrich, modify, and classify the physical layout information into progressively more advanced physical layout information and, ultimately, semantic layout information. The semantic layout information is mapped and serialized into a selected flow format document with a high level of flowability.

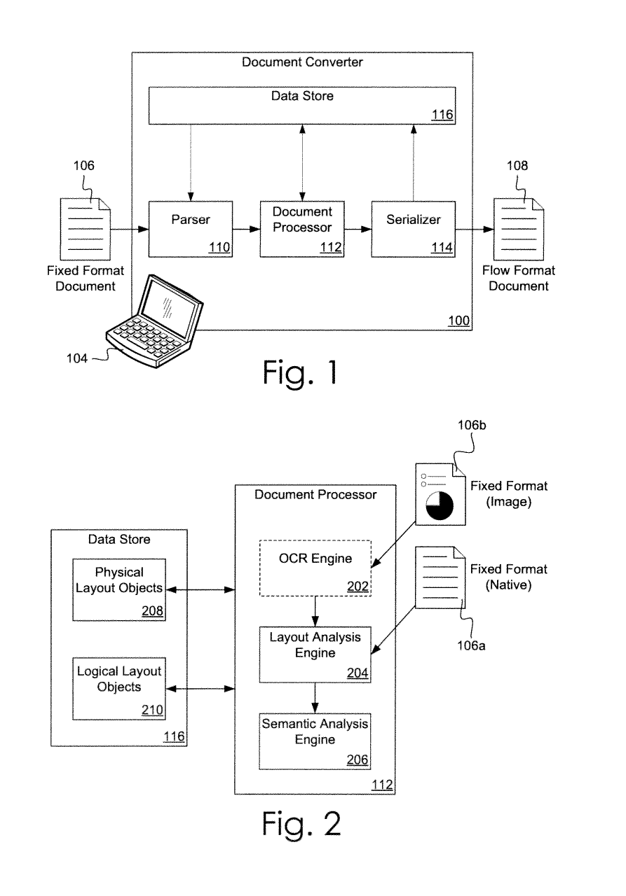

FIG. 1 illustrates a system incorporating the fixed format document conversion engine 100. In the illustrated embodiment, the fixed format document conversion engine 100 is executed on a computing device 104. A fixed format document 106 is converted into a flow format document 108 via a parser (i.e., parsing engine) 110, a document processor 112, and a serializer 114. The parser 110 extracts data from the fixed format document 106. The data extracted from the fixed format document is written to a data store 116 accessible by the document processor 112 and the serializer 114. The document processor 112 analyzes and transforms the data into flowable elements using one or more detection and/or reconstruction engines (e.g., the fixed format document conversion engine 100 of the present invention). Finally, the serializer 114 writes the flowable elements into a flowable document format (e.g., a word processing format).

FIG. 2 illustrates one embodiment of the operational flow of the document processor 112 in greater detail. The document processor 112 includes an optional optical character recognition (OCR) engine 202, a layout analysis engine 204, and a semantic analysis engine 206. The data contained in the data store 116 includes physical layout objects 208 and logical layout objects 210. In some embodiments, the physical layout objects 208 and logical layout objects 210 are hierarchically arranged in a tree-like array of groups (i.e., data objects). In various embodiments, a page is the top level group for the physical layout objects 208, and a section is the top level group for the logical layout objects 210. The data extracted from the fixed format document 106 is generally stored as physical layout objects 208 organized by the containing page in the fixed format document 106. The basic physical layout objects obtained from a fixed format document include text-runs, images, and paths. Text-runs are the text elements in page content streams specifying the positions where characters are drawn when displaying the fixed format document. Images are the raster images (i.e., pictures) stored in the fixed format document 106. Paths describe elements such as lines, curves (e.g., cubic Bezier curves), and text outlines used to construct vector graphics.

Where processing begins depends on the type of fixed format document 106 being parsed. A native fixed format document 106a created directly from a flow format source document contains the some or all of the basic physical layout elements. Generally, the data extracted from a native fixed format document 106a is available for immediate use by the document converter; although, in some instances, minor reformatting or other minor processor is applied to organize or standardize the data. In contrast, all information in an image-based fixed format document 106b created by digitally imaging a physical document (e.g., scanning or photographing) is stored as a series of page images with no additional data (i.e., no text-runs or paths). In this case, the optional optical character recognition engine 202 analyzes each page image and creates corresponding physical layout objects. Once the physical layout objects 208 are available, the layout analysis engine 204 determines the layout of the fixed format document and enriches the data store with new information (e.g., adds, removes, and updates the physical layout objects). After layout analysis is complete, the semantic analysis engine 206 enriches the data store with semantic information obtained from analysis of the physical layout objects and/or logical layout objects.

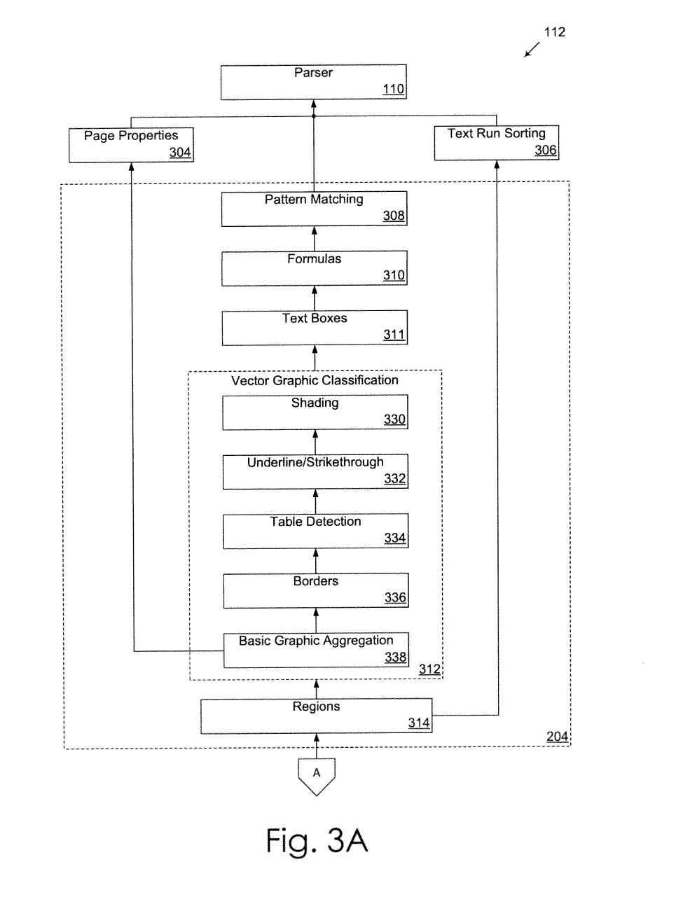

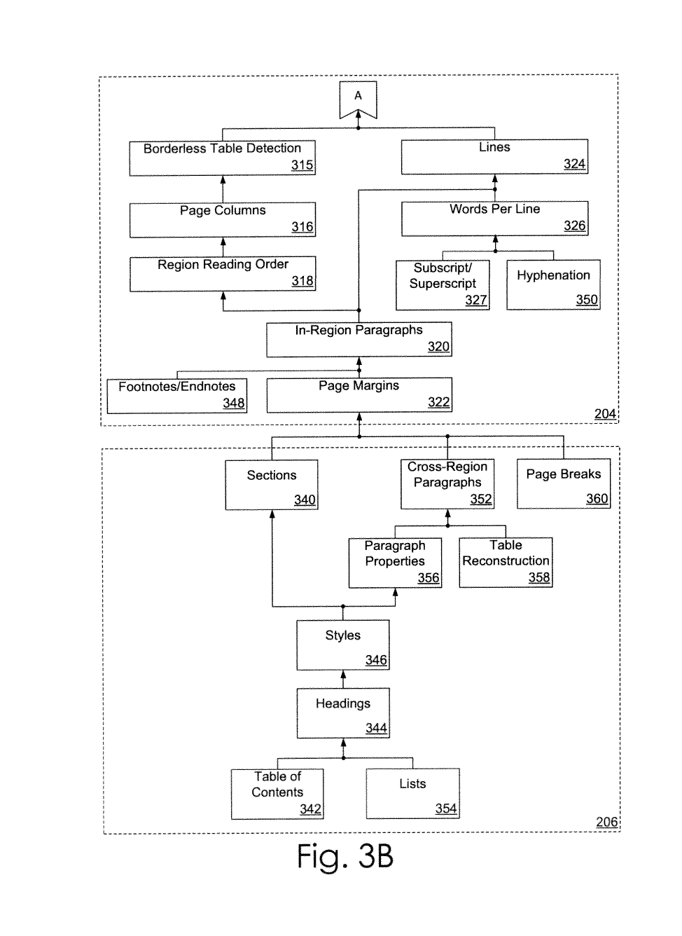

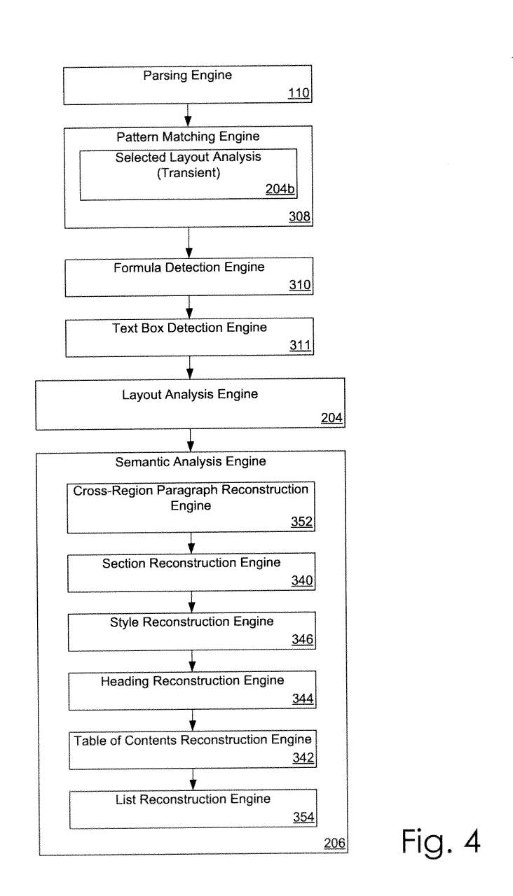

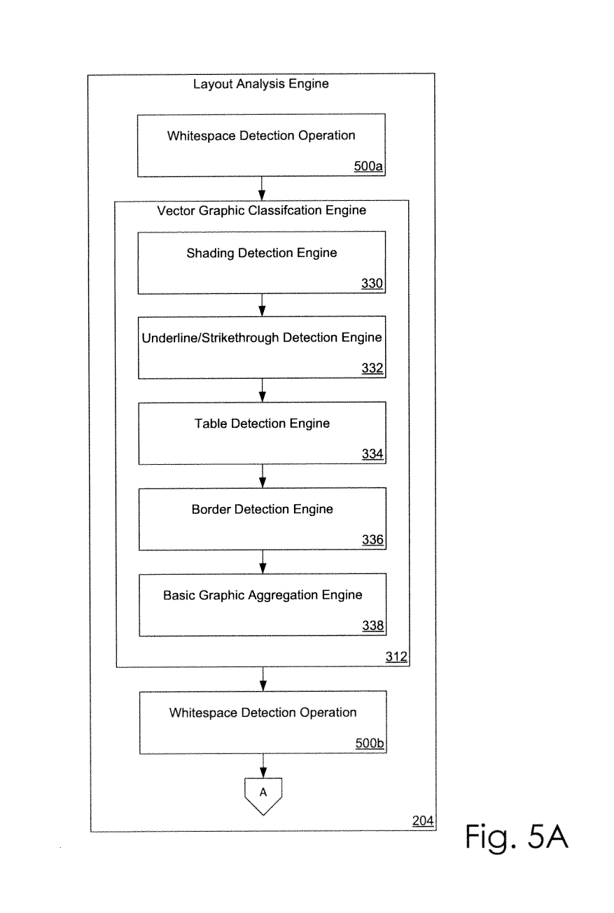

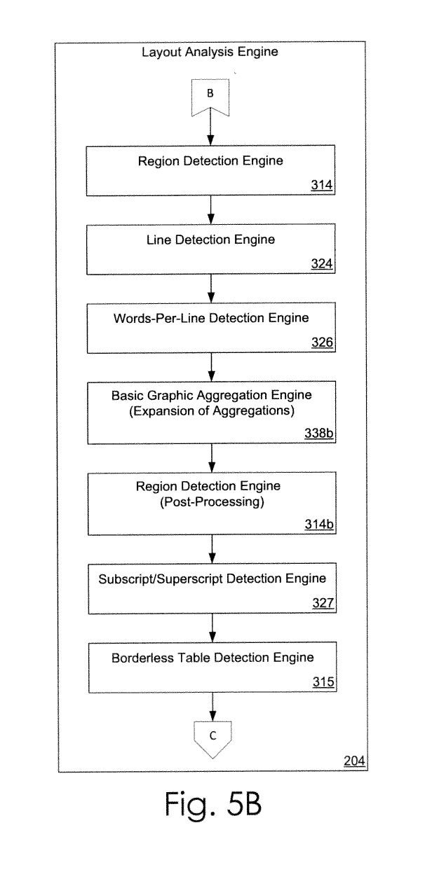

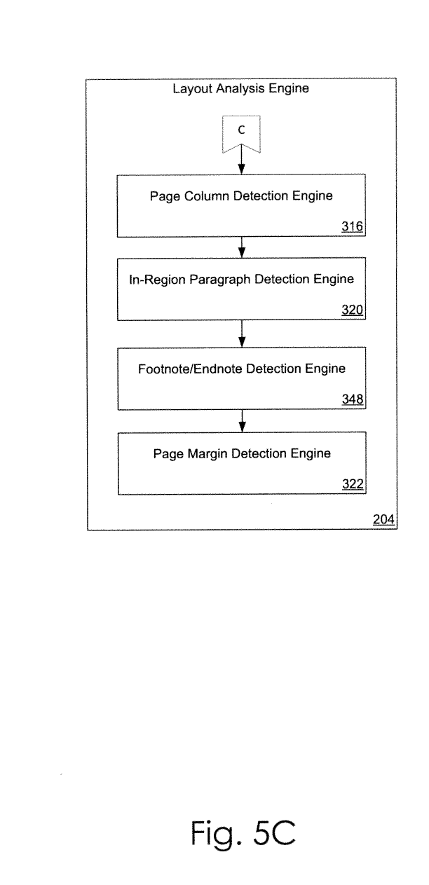

FIGS. 3A-B form a single block diagram showing the dependencies of the various engines that are part of the fixed format document conversion engine 100. FIG. 4 illustrates a flow diagram showing the order in which the various engines are executed by the fixed format document conversion engine. FIGS. 5A-C form a single flow diagram showing one embodiment of the functions performed by the layout analysis engine 204. Due to the interrelated nature, FIGS. 3A-5C are discussed together. Although each engine is described as depending upon the engine immediately prior, it should appreciated that the engine in question should generally be considered as also depending upon any engines and/or operations upon which the immediately prior engine depends as illustrated in FIGS. 3A-B.

The fixed format document conversion engine includes a layout analysis engine 204 and a semantic analysis engine 206. The layers of the parser 110 appearing in the dependency diagram of FIG. 3A include a page properties layer 304 and a text run sorting layer 306. The detection engines of the layout analysis engine 204 appearing in the dependency diagram of FIG. 3A include a pattern matching engine 308, a formula detection engine 310, a text box detection engine 311, a vector graphic classification engine 312, a region detection engine 314, a borderless table detection engine 315, a page column detection engine 316, a region reading order detection operation 318, an in-region paragraph detection engine 320, a page margin detection engine 322, a footnote/endnote detection engine 348, a hyphenation operation 350, a line detection engine 324, a words-per-line detection engine 326, and a subscript/superscript detection engine 327. The vector graphic classification engine 312 includes a shading detection engine 330, an underline/strikethrough detection engine 332, a border detection engine 336, a table detection engine 334, and a basic graphic aggregation engine 338.

The reconstruction engines and operations of the semantic analysis engine 206 appearing in the dependency diagram of FIG. 3B include a section reconstruction engine 340, a table of contents reconstruction engine 342, a heading reconstruction engine 344, a style reconstruction engine 346, a cross-region paragraph reconstruction engine 352, a list reconstruction engine 354, a paragraph properties reconstruction operation 356, a table reconstruction operation 358, and a page break reconstruction operation 360. The reconstruction operations are specific operations performed as part of a reconstruction engine such as the cross-region paragraph reconstruction engine 352.

Working together and in sequence, the detection engines in the layout analysis engine 204 and the reconstruction engines in the semantic analysis engine 206 analyze the base physical layout information obtained from the fixed format document to enrich, modify, and classify the physical layout information into progressively more advanced physical layout information and, ultimately, semantic layout information. In the embodiment of FIG. 4, the operational flow of the fixed format document conversion engine includes executing the following detection and/or reconstruction engines and operations in substantially the following order: the parser 110, the pattern matching engine 308, the formula detection engine 310, the text box detection engine 311, the layout analysis engine 204, the cross-region paragraph reconstruction engine 352, the section reconstruction engine 340, the style reconstruction engine 346, the heading reconstruction engine 344, the table of contents reconstruction engine 342, and the list reconstruction engine 354. The operational flow of the layout analysis engine illustrated in FIGS. 5A-C includes executing the following detection and/or reconstruction engines and operations substantially in order on each page of the fixed format document a whitespace detection operation 500a, the vector graphic classification engine 312, another whitespace detection operation 500b, the region detection engine 314, the line detection engine 324, the words-per-line detection engine 326, a basic graphic aggregation expansion operation 338b, a region post-processing operation 314b, the subscript/superscript detection engine 327, the borderless table detection engine 315, the page column detection engine 316, the in-region paragraph detection engine 320, a footnote/endnote detection engine 348, and a page margin detection engine 322. The semantic layout information is mapped and serialized into a selected flow format document with a high level of flowability.

The detection and/or reconstruction engines are executed in the order discussed herein due to the dependency of certain engines on the results of one or more prior detection or reconstruction engines. The detection engines of the layout analysis engine 204 analyze physical layout objects and enrich the data store with new information related to the physical layout of the document. The reconstruction engines of the semantic analysis engine 206 analyze physical layout objects and logical layout objects and enrich the data store with new information related to the logical layout of the document. A summary of functions of the various detection and reconstruction engines follows. The summary notes any other engine that the detection or reconstruction depends on and the order of execution in the fixed format document conversion engine pipeline. The inter-engine dependencies and execution order described above and illustrated in FIGS. 3A-5C represent one embodiment of the overall fixed format document conversion engine. A certain amount of variation is contemplated. For example, in some embodiments, selected engines may be omitted from the fixed format document conversion process. In such cases, an engine is presumed to be dependent on the next higher parent engine. Further, in some embodiments, the execution order of selected engines may vary where the engines are not directly dependent upon each other.

The page properties layer 304 is a parser layer that determines simple page properties, such as page size and orientation, from the fixed format document during parsing. In the embodiment illustrated in FIG. 3A, the page properties layer 304 generally depends on the operation of the parser 110.

The text run sorting layer 306 is a parser layer that sorts text runs based on rendering order during parsing of the fixed format document 106. In the embodiment illustrated in FIG. 3A, the text run sorting layer 306 generally depends on the operation of the parser 110.

The pattern matching engine 308 is a layout analysis engine that detects repeating elements that have substantially similar content and appear in substantially similar positions throughout the document. In various embodiments, the pattern matching engine 308 detects headers, footers, watermarks, page colors, page borders, and page numbers. Some embodiments of pattern matching engine 308 execute selected detection engines of the layout analysis engine 204b to detect and reconstruct header and footer areas; however, the results are transient and used only by the pattern matching engine 308. In the embodiment illustrated in FIGS. 3A-B, the pattern matching engine 308 generally depends on the operation of the parser 110 and is not dependent on the analysis of any other detection engine. In the embodiment illustrated in FIGS. 4-5C, the pattern matching engine 308 is executed after the parsing engine 110 completes extraction of data from the fixed format document.

The formula detection engine 310 is a layout analysis engine that detects formulas in a text run based on the presence of formula seeds. In the embodiment illustrated in FIGS. 3A-B, the formula detection engine 310 is dependent on the analysis performed by the pattern matching engine 308. In the embodiment illustrated in FIGS. 4-5C, the formula detection engine 310 is executed after the pattern matching engine 308 completes its analysis.

The text box detection engine 311 is a layout analysis engine that detects text runs intersecting an area outside of the page margins. A text box is not necessarily bounded by a visible box. In the embodiment illustrated in FIGS. 3A-B, the text box detection engine 311 is dependent on the analysis performed by the formula detection engine 310. In the embodiment illustrated in FIGS. 4-5C, the text box detection engine 311 is executed after the formula detection engine 310 completes its analysis.

The whitespace detection operation 500a is a layout analysis operation that detects the bounding boxes of areas of whitespace on a page (i.e., areas containing no text runs, paths, or images). In some embodiments, the whitespace detection operation is performed as part of another layout analysis engine. In other embodiments, the whitespace detection operation is performed by a dedicated whitespace detection engine. The whitespaces are used for detecting underline and strikethrough formatting, highlighting, shading, borders (e.g., boxes), and regions. In various embodiments, the whitespace detection engine has no specific dependencies and does not make any changes in the data store. In the embodiment illustrated in FIGS. 4-5C, the whitespace detection operation 500a is performed after the text box detection engine 311 completes its analysis.

The vector graphic classification engine 312 is a layout analysis engine that classifies vector graphics using a number of sub-engines including the shading detection engine 330, underline/strikethrough detection engine 332, the table detection engine 334, the border detection engine 336, and the basic graphic aggregation engine 338. In the embodiment illustrated in FIGS. 3A-B, the vector graphic classification engine 312 is dependent on the analysis performed in by the text box detection engine 311. In the embodiment illustrated in FIGS. 4-5C, the vector graphic classification engine 312 is executed after the text box detection engine 311 completes its analysis.

The shading detection engine 330 is a layout analysis engine that detects paths that form rectangles or similar shapes that bound a text run and contain fill (i.e., a background fill color). All paths that are detected as shading are removed from the page and the corresponding text-runs are updated with the appropriate shading properties. In the embodiment illustrated in FIGS. 3A-B, the shading detection engine 330 is dependent on the analysis performed by the underline/strikethrough detection engine 332. In the embodiment illustrated in FIGS. 4-5C, the shading detection engine 330 is executed after completion of the whitespace detection operation 500a.

The underline/strikethrough detection engine 332 is a layout analysis engine that detects paths that are directly underneath or overlapping a text run. All paths that are detected as underlines/strikethroughs are removed from the page and the corresponding text-run elements/nodes are updated with the appropriate underline and/or strikethrough properties. In the embodiment illustrated in FIGS. 3A-B, the underline/strikethrough detection engine 332 is dependent on the analysis performed by the shading detection engine 330. In the embodiment illustrated in FIGS. 4-5C, the underline/strikethrough detection engine 332 is executed after the shading detection engine 330 completes its analysis.

The table detection engine 334 is a layout analysis engine that tables with visible borders. In order to simplify the detection of regions, all graphics objects that potentially represent table borders are aggregated. The table detection engine locates the borders for each cell of the table. Additionally, the table detection engine 334 invokes selected layout analysis engines to perform layout analysis on each cell of the table. In the embodiment illustrated in FIGS. 3A-B, the table detection engine 334 is dependent on the analysis performed by the underline/strikethrough detection engine 332. In the embodiment illustrated in FIGS. 5A-C, the table detection engine 334 is executed after the underline/strikethrough detection engine 332 completes its analysis.

The border detection engine 336 is a layout analysis engine that detects paths that form rectangles or similar shapes that bound a text run and do contain fill. All paths that are detected as borders are removed from the page and the corresponding text-runs are updated with the appropriate border properties. In the embodiment illustrated in FIGS. 3A-B, the border detection engine 336 is dependent on the analysis performed by the table detection engine 334. In the embodiment illustrated in FIGS. 4-5C, the border detection engine 336 is executed after the table detection engine 334 completes its analysis.

The basic graphic aggregation engine 338 is a layout analysis engine that aggregates all remaining graphical elements naturally belonging to a single entity based on overlap, proximity, or other similar characteristics. Basic graphic are not limited to images, but include shapes and text-runs that are intended to be a part of single entity. In the embodiment illustrated in FIGS. 3A-B, the basic graphic aggregation engine 338 is dependent on the analysis performed by the border detection engine 336. In the embodiment illustrated in FIGS. 4-5C, the basic graphic aggregation engine 338 is executed after the border detection engine 336 completes its analysis.

The region detection engine 314 is a layout analysis engine that uses information about bounding boxes of text-runs and page properties to divide the entire document into blocks (i.e., regions) that can be processed independently. In various embodiments, each table cell is treated as a separate page for the purpose of region detection. After region detection, all text-runs on the page are divided among regions with no text-runs remaining as children of the page node. In the embodiment illustrated in FIGS. 3A-B, the region detection engine 314 is dependent on the analysis performed by the vector graphic classification engine 312. In the embodiment illustrated in FIGS. 4-5C, the region detection engine 314 is executed after the vector graphic classification engine 312 completes its analysis. Further, in the embodiment illustrated in FIGS. 4-5C, the whitespace detection operation 500b is performed again after the basic graphic aggregation engine 338 completes its analysis.

The page column detection engine 316 is a layout analysis engine that detects columns on a page level. Page columns are detected to all correctly establish the reading order of the page. After region detection, corresponding columns should be in vertically parallel regions, so those regions need to be treated adequately in order to recreate the columns. In the embodiment illustrated in FIGS. 3A-B, the page column detection engine 316 is dependent on the analysis performed by the region detection engine 314. In the embodiment illustrated in FIGS. 4-5C, the page column detection engine 316 is executed after the borderless table detection engine 315 completes its analysis.

The region reading order detection operation 318 is an operation performed by one or more layout analysis engines (e.g., the region detection engine 314) that determine the reading order of text runs within a region. After region detection, the reading order of the regions is roughly determined by sorting them from top-left to bottom-right corner, but also information about detected columns need to be taken into account. Further, additional analysis needs to be done in order to support languages that do not read from left to right. In the embodiment illustrated in FIGS. 3A-B, the region reading order detection operation 318 is dependent on the analysis performed by the page column detection engine 316.

The in-region paragraph detection engine 320 is a layout analysis engine that combines the lines within a region into paragraphs. After in-region paragraph detection, all lines in the region are divided among paragraphs with no lines remaining as children of the region nodes. In the embodiment illustrated in FIGS. 3A-B, the in-region paragraph detection engine 320 is dependent on the analysis performed by the region reading order detection operation 318 and the line detection engine 324. In the embodiment illustrated in FIGS. 4-5C, the in-region paragraph detection engine 320 is executed after the page column detection engine 316 completes its analysis.

The page margin detection engine 322 is a layout analysis engine that calculates page margins to fit the geometry of paragraphs. In the embodiment illustrated in FIGS. 3A-B, the page margin detection engine 322 is dependent on the analysis performed by the in-region paragraph detection engine 320 completes its analysis. In the embodiment illustrated in FIGS. 4-5C, the page margin detection engine 322 is executed after the footnote/endnote detection engine 348 completes its analysis.

The line detection engine 324 is a layout analysis engine that combines text-runs within each region into lines based on the position of the text-runs within the regions and relative to each other. After line detection, all text-runs within each region are divided among lines with no text runs remaining as children of the region In the embodiment illustrated in FIGS. 3A-B, the line detection engine 324 is dependent on the analysis performed by the region detection engine 314. In the embodiment illustrated in FIGS. 4-5C, the line detection engine 324 is executed after the region detection engine 314 completes its analysis.

The words-per-line detection engine 326 is a layout analysis engine that detects all words appearing in a single line. In the embodiment illustrated in FIGS. 3A-B, the words-per-line detection engine 326 is dependent on the analysis performed by the line detection engine 324. In the embodiment illustrated in FIGS. 4-5C, the words-per-line detection engine 326 is executed after the line detection engine 324 completes its analysis.

The hyphenation operation 350 is an operation performed by the line detection engine 324 or the word-per-line detection engine 326 that reconstructs hyphenation of words. In the embodiment illustrated in FIGS. 3A-B, the hyphenation operation 350 is dependent on the analysis performed by the word-per-line detection engine 326.1n an alternate embodiment, the hyphenation operation 350 is dependent on the analysis performed by the line detection engine 324.

In the embodiment illustrated in FIGS. 4-5C, the layout analysis engine 204 executes the basic graphic aggregation engine 338 again after the words-per-line detection engine 326 completes its analysis to perform a basic graphic aggregation expansion operation 338b.

The region post-processing operation 314b of the region detection engine 314 performs various operations to detect features such as line numbering. In the embodiment illustrated in FIGS. 3A-B, the region post-processing operation 314b has no specific dependencies indicated; however, at a minimum it includes the dependencies of the region detection engine 314. In various embodiments, the region post-processing operation 314b further depends on any or all of the analysis performed by the line detection engine 324, the words-per-line detection engine 326, and the basic graphic aggregation expansion operation 338b. In the embodiment illustrated in FIGS. 4-5C, the region post-processing operation 314b is performed after completion of the basic graphic aggregation expansion operation 338b.

The subscript/superscript detection engine 327 is a layout analysis engine that detects all subscripts/superscripts based on the position of a text run relative to the line position. In the embodiment illustrated in FIGS. 3A-B, the subscript/superscript detection engine 327 is dependent on the analysis performed by the words-per-line detection engine 326. In the embodiment illustrated in FIGS. 4-5C, the subscript/superscript detection engine 327 is executed after the words-per-line detection engine 326 completes its analysis.

The borderless table detection engine 315 is a layout analysis engine that uses whitespaces to identify structured regions of text that constitute borderless tables. In the embodiment illustrated in FIGS. 3A-B, the borderless table detection engine 315 is dependent on the analysis performed by the region detection engine 314. In the embodiment illustrated in FIGS. 4-5C, the borderless table detection engine 315 is executed after the subscript/superscript detection engine 327 completes its post-processing analysis.

The footnote/endnote detection engine 348 identifies and reconstructs footnotes and endnotes. In the embodiment illustrated in FIGS. 3A-B, the footnote/endnote detection engine 348 is dependent on the analysis performed by the in-region paragraph detection engine 320. In an alternate embodiment, the footnote/endnote detection engine 348 is dependent on the analysis performed by the page margin detection engine 322. In the embodiment illustrated in FIGS. 4-5C, the footnote/endnote detection engine 348 is executed after the in-region paragraph detection engine 320 completes its analysis.

The cross-region paragraph reconstruction engine 352 is a semantic analysis engine that identifies and corrects paragraphs split across multiple regions and/or pages. In the embodiment illustrated in FIGS. 3A-B, the cross-region paragraph reconstruction engine 352 is dependent on the analysis performed by the page margin detection engine 322. In the embodiment illustrated in FIGS. 4-5C, the cross-region paragraph reconstruction engine 352 is executed after the layout analysis engine 204, and more specifically, the page margin detection engine 322 completes its analysis.

The section reconstruction engine 340 is a semantic analysis engine that creates a new section when selected events occur such as a restarting page numbers. In the embodiment illustrated in FIGS. 3A-B, section reconstruction engine 340 is dependent on the analysis performed by the page margin detection engine 322. In the embodiment illustrated in FIG. 4, the section reconstruction engine 340 is executed after the cross-region paragraph reconstruction engine 352 completes its analysis.

The style reconstruction engine 346 is a semantic analysis engine that analyzes paragraphs and collects different text formatting styles. After collecting styles document wide, a rule engine is used to create definitions for some standard style definitions. In the embodiment illustrated in FIGS. 3A-B, the style reconstruction engine 346 is dependent on the analysis performed by the section reconstruction engine 340. In the embodiment illustrated in FIGS. 4-5C, the style reconstruction engine 346 is executed after the section reconstruction engine 340 completes its analysis.

The heading reconstruction engine 344 is a semantic analysis engine that reconstructs headings. In the embodiment illustrated in FIGS. 3A-B, the heading reconstruction engine 344 is dependent on the analysis performed by the style reconstruction engine 346. In the embodiment illustrated in FIGS. 4-5C, the heading reconstruction engine 344 is executed after the style reconstruction engine 346 completes its analysis.

The table of contents reconstruction engine 342 is a semantic analysis engine that identifies and reconstructs table of contents and other reference tables. In the embodiment illustrated in FIGS. 3A-B, the table of contents reconstruction engine 342 is dependent on the analysis performed by the heading reconstruction engine 344. In the embodiment illustrated in FIGS. 4-5C, the table of contents reconstruction engine 342 is executed after the heading reconstruction engine 344 completes its analysis.

The list reconstruction engine 354 is a semantic analysis engine that identifies and reconstructs bulleted and numbered lists based on the horizontal offset of the members. In the embodiment illustrated in FIGS. 3A-B, the list reconstruction engine 354 is dependent on the analysis performed by the heading reconstruction engine 344. In the embodiment illustrated in FIGS. 4-5C, the list reconstruction engine 354 is executed after the table of contents reconstruction engine 342 completes its analysis.

The paragraph properties reconstruction operation 356 is an operation that identifies and corrects paragraph properties during the transition from physical layout objects to logical layout objects. In the embodiment illustrated in FIGS. 3A-B, the paragraph properties reconstruction operation 356 is dependent on the analysis performed by the cross-region paragraph reconstruction engine 352. In one embodiment, the paragraph properties reconstruction operation 356 is executed as part of the cross-region paragraph reconstruction engine 352.

The table reconstruction operation 358 is an operation that recreates the content and properties of tables during the transition from physical layout objects to logical layout objects. Each table cell is subject to complete layout analysis using one or more of the layout analysis engines. In the embodiment illustrated in FIGS. 3A-B, the table reconstruction operation 358 is dependent on the analysis performed by the cross-region paragraph reconstruction engine 352 completes its analysis. In one embodiment, the table reconstruction operation 358 is executed as part of the cross-region paragraph reconstruction engine 352.

The page break reconstruction operation 360 is an operation that recreates page breaks during the transition from physical layout objects to logical layout objects. In the embodiment illustrated in FIGS. 3A-B, the page break reconstruction operation 360 is dependent on the analysis performed by the page margin detection engine 322. In one embodiment, the page break reconstruction operation 360 is executed as part of the cross-region paragraph reconstruction engine 352.

The dependencies and execution order described above and illustrated in FIGS. 3A-5C represent one embodiment of the overall fixed format document conversion engine. A certain amount of variation is contemplated. For example, in some embodiments, selected engines may be omitted from the fixed format document conversion process. In such cases, an engine is presumed to be dependent on the next higher parent engine. In other embodiments, the execution of some engines may be altered where the one engine does not depend on the other (i.e., the engines are unrelated). By way of example, omission of the subscript/superscript detection engine 327 would not adversely impact the operation of the cross-region paragraph reconstruction engine 352.

The fixed format document conversion engine and associated fixed format document conversion method described herein is useful to convert various fixed format elements in a fixed format document into the appropriate corresponding flow format element. While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

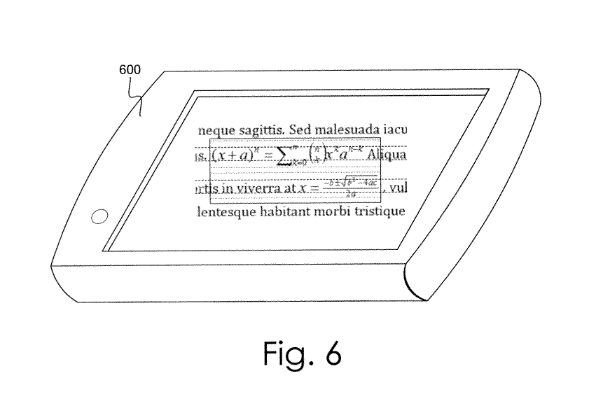

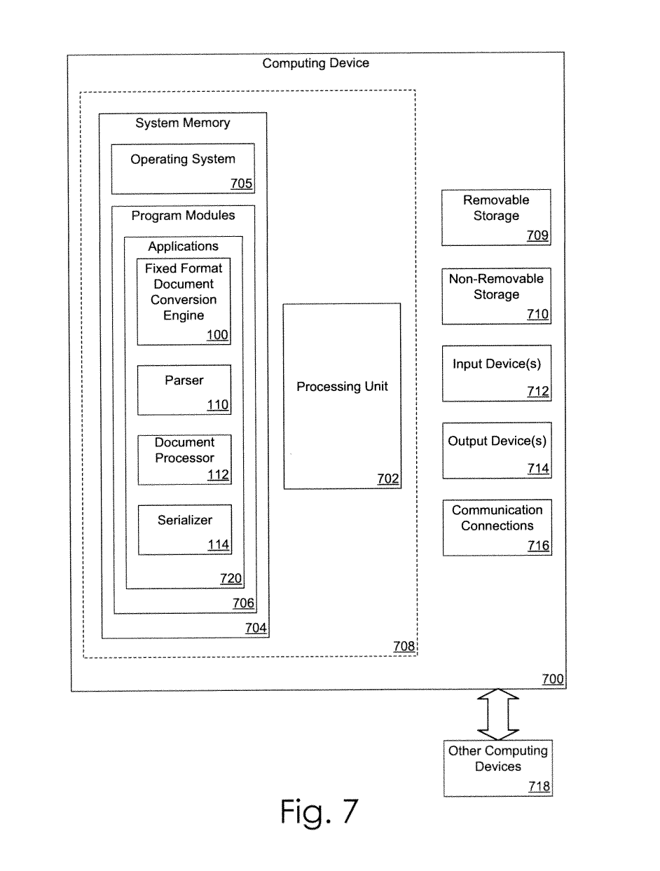

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers. FIG. 6 illustrates an exemplary tablet computing device 600 executing an embodiment of the fixed format document conversion engine 100. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 7 through 9 and the associated descriptions provide a discussion of a variety of operating environments in which embodiments of the invention may be practiced. However, the devices and systems illustrated and discussed with respect to FIGS. 7 through 9 are for purposes of example and illustration and are not limiting of a vast number of computing device configurations that may be utilized for practicing embodiments of the invention, described herein.

FIG. 7 is a block diagram illustrating example physical components (i.e., hardware) of a computing device 700 with which embodiments of the invention may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 720 such as the fixed format document conversion engine 100, the parser 110, the document processor 112, and the serializer 114. The operating system 705, for example, may be suitable for controlling the operation of the computing device 700. Furthermore, embodiments of the invention may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706, such as the fixed format document conversion engine 100, the parser 110, the document processor 112, and the serializer 114 may perform processes including, for example, one or more of the stages of the fixed format document conversion method. The aforementioned process is an example, and the processing unit 702 may perform other processes. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the fixed format document conversion engine 100, the parser 110, the document processor 112, and the serializer 114 may be operated via application-specific logic integrated with other components of the computing device 700 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 700 may also have one or more input device(s) 712 such as a keyboard, a mouse, a pen, a sound input device, a touch input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, or serial ports, and other connections appropriate for use with the applicable computer readable media.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media and communication media. Computer storage media may include volatile and nonvolatile, removable and non-removable media implemented in any method or technology for storage of information, such as computer readable instructions, data structures, program modules, or other data. The system memory 704, the removable storage device 709, and the non-removable storage device 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 700. Any such computer storage media may be part of the computing device 700.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

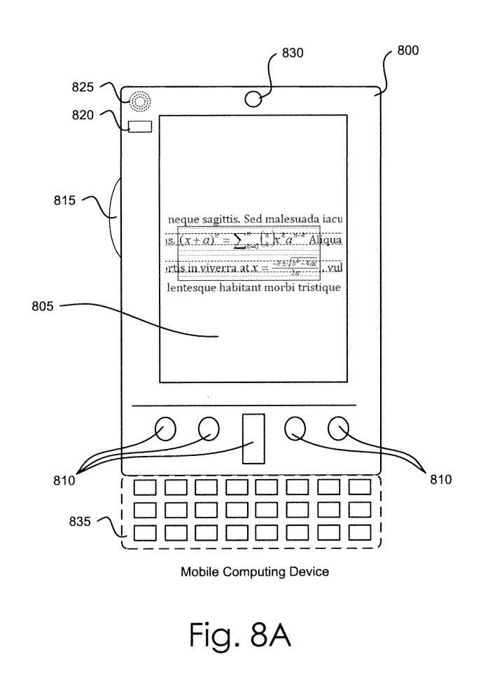

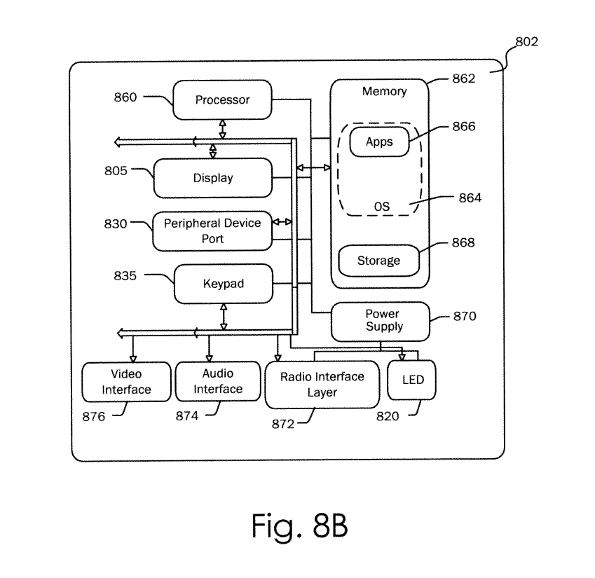

FIGS. 8A and 8B illustrate a mobile computing device 800, for example, a mobile telephone, a smart phone, a tablet personal computer, a laptop computer, and the like, with which embodiments of the invention may be practiced. With reference to FIG. 8A, an exemplary mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some embodiments, the mobile computing device 800 incorporates a vibration transducer for providing the user with tactile feedback. In yet another embodiment, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 800 can incorporate a system (i.e., an architecture) 802 to implement some embodiments. In one embodiment, the system 802 is implemented as a “smart phone” capable of running one or more applications (e.g., browser, e-mail, calendaring, contact managers, messaging clients, games, and media clients/players). In some embodiments, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including the fixed format document conversion engine 100, the parser 110, the document processor 112, and the serializer 114 described herein.

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the function of transmitting and receiving radio frequency communications. The radio 872 facilitates wireless connectivity between the system 802 and the “outside world”, via a communications carrier or service provider. Transmissions to and from the radio 872 are conducted under control of the operating system 864. In other words, communications received by the radio 872 may be disseminated to the application programs 866 via the operating system 864, and vice versa.

The radio 872 allows the system 802 to communicate with other computing devices, such as over a network. The radio 872 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 802 provides notifications using the visual indicator 820 that can be used to provide visual notifications and/or an audio interface 874 producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present invention, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868. Computer storage media may include volatile and nonvolatile, removable and non-removable media implemented in any method or technology for storage of information, such as computer readable instructions, data structures, program modules, or other data.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

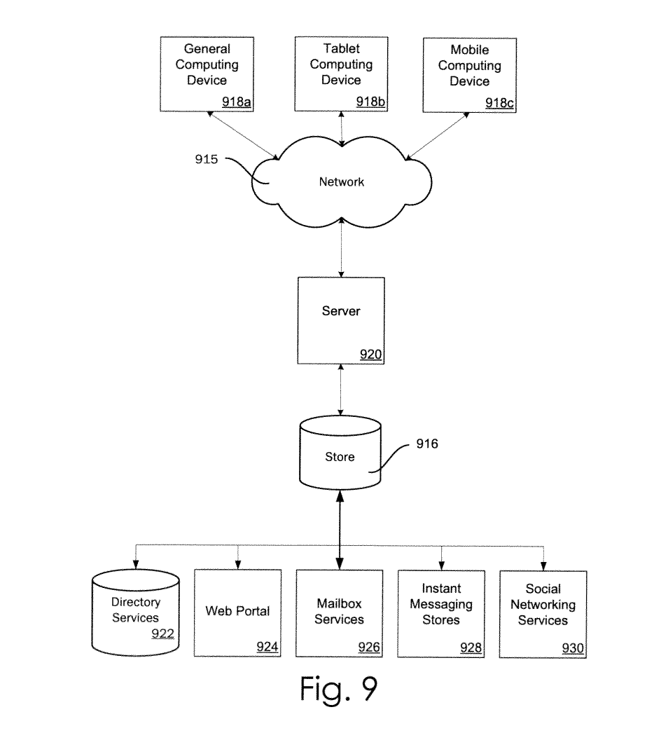

FIG. 9 illustrates one embodiment of the architecture of a system for providing the fixed format document conversion engine 100, the parser 110, the document processor 112, and the serializer 114 to one or more client devices, as described above. Content developed, interacted with or edited in association with the fixed format document conversion engine 100, the parser 110, the document processor 112, and the serializer 114 may be stored in different communication channels or other storage types. For example, various documents may be stored using a directory service 922, a web portal 924, a mailbox service 926, an instant messaging store 928, or a social networking site 930. The fixed format document conversion engine 100, the parser 110, the document processor 112, and the serializer 114 may use any of these types of systems or the like for enabling data utilization, as described herein. A server 920 may provide the fixed format document conversion engine 100, the parser 110, the document processor 112, and the serializer 114 to clients. As one example, the server 920 may be a web server providing the fixed format document conversion engine 100, the parser 110, the document processor 112, and the serializer 114 over the web. The server 920 may provide the fixed format document conversion engine 100, the parser 110, the document processor 112, and the serializer 114 over the web to clients through a network 915. By way of example, the client computing device 918 may be implemented as the computing device 900 and embodied in a personal computer 918a, a tablet computing device 918b and/or a mobile computing device 918c (e.g., a smart phone). Any of these embodiments of the client computing device 918 may obtain content from the store 916. In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

What is claimed is:

1. A method for converting a fixed format document into a flow format document, said method comprising the steps of:
storing information extracted from a fixed format document as physical layout objects, said physical layout objects arranged hierarchically based on physical relationships between said physical layout objects;
enriching said physical layout objects using a selected sequence of layout analysis operations to analyze the physical layout of the fixed format document wherein said selected sequence of layout analysis operations is dependency based on a results from at least one prior said layout analysis operation; and
enriching logical layout objects using a selected sequence of semantic analysis operations to analyze the physical layout of the fixed format document wherein said sequence of semantic analysis operations is dependency based on a results from at least one prior said semantic analysis operation or said layout analysis operation.

2. The method of claim 1 characterized in that said step of enriching said physical layout objects comprises the steps of:
detecting whitespace in the fixed format document;
detecting shading in the fixed format document after said step of detecting whitespace;
detecting underline and strikethrough in the fixed format document after said step of detecting shading;
detecting borders in the fixed format document after said step of detecting underline and strikethrough;
detecting tables in the fixed format document after said step of detecting boxes;
aggregating basic graphics in the fixed format document after said step of detecting tables;
detecting whitespace in the fixed format document after said step of aggregating basic graphics;
detecting regions in the fixed format document after said step of detecting whitespace;
detecting page columns in the fixed format document after said step of detecting regions;
detecting lines in the fixed format document after said step of detecting page columns;
detecting words per line in the fixed format document after said step of detecting lines;
expanding basic graphic aggregations in the fixed format document after said step of detecting words per line;
post-processing regions in the fixed format document after said step of expanding basic graphic aggregations;
detecting subscripts and superscripts in the fixed format document after said step of post-processing regions;
detecting borderless tables in the fixed format document after said step of post-processing regions;
detecting paragraphs appearing in a single region or page in the fixed format document after said step of post-processing regions;
detecting footnotes and endnotes in the fixed format document after said step of detecting paragraphs; and
detecting page margins in the fixed format document after said step of detecting paragraphs.

3. The method of claim 1 characterized in that said step of enriching said logical layout objects comprises the steps of:
reconstructing paragraphs spanning more than one said physical layout object;
reconstructing sections after said step of reconstructing paragraphs;
reconstructing headings after said step of reconstructing sections;
reconstructing text formatting styles after said step of reconstructing headings;
reconstructing tables of references after said step of reconstructing text formatting styles; and
reconstructing bulleted and/or numbered lists after said step of reconstructing tables of references.

4. The method of claim 1:
characterized in that said step of enriching said physical layout objects further comprises the step of executing a selected layout analysis engine from a plurality of layout analysis engines dependent on at least one of an availability of said physical layout objects and at least one parent engine selected from said plurality of layout analysis engines and plurality of said semantic analysis engines after said physical layout objects are available and all said parent engines of said selected semantic analysis engine have finished execution; and
characterized in that said step of enriching said logical layout objects further comprises the step of executing a selected semantic analysis engine from a plurality of semantic analysis engines dependent at least one parent engine selected from said plurality of layout analysis engines and said plurality of semantic analysis engines after all said parent engines of said selected semantic analysis engine have finished execution.

5. The method of claim 1 characterized in that said physical layout objects correspond to text runs, paths, and images extracted from the fixed format document.

6. The method of claim 1 characterized in that said logical layout objects correspond to semantic elements of a flow format document.

7. The method of claim 1 further comprising the step of serializing said logical layout objects to create a flow format document corresponding to the fixed format document using said plurality of said logical layout objects and said plurality of physical layout objects.

8. The method of claim 1 further comprising the step of arranging said plurality of physical layout objects in a tree-like array of nodes with page nodes being a top level said physical layout object.

9. The method of claim 1 further comprising the step of arranging said plurality of logical layout objects in a tree-like array of nodes with section nodes being a top level said physical layout object.

10. A system for a fixed format document into a flow format document, said system comprising a fixed format document conversion engine further comprising:
a physical layout data store operable to store a plurality of physical layout objects, each said physical layout object having a hierarchal relationship to another said physical layout object based on physical position;
a logical layout data store operable to store a plurality of logical layout objects, each said logical layout object having a hierarchal relationship to another said logical layout object based on semantic position;
a parsing engine operable to extract information from a fixed format document and storing said information in selected said physical layout objects corresponding to at least one of text runs, paths, and images;
a plurality of layout analysis engines operable to operable to enrich at least one of said plurality of physical layout objects based on analysis of said plurality of physical layout objects, each said layout analysis engine dependent on at least one of another engine selected from said parsing engine and said plurality of layout analysis engines; and
a plurality of semantic analysis engines operable to enrich at least one of said plurality of logical layout objects based on analysis of said plurality of physical layout objects, each said semantic analysis engine dependent on at least one analysis engine selected from said plurality of text analysis engines and said plurality of semantic analysis engines, said plurality semantic analysis engines.

11. The system of claim 10 further comprising a serializing engine operable to create a flow format document corresponding to the fixed format document based on said plurality of said logical layout objects and said plurality of physical layout objects.

12. The system of claim 10 characterized in that said physical layout objects correspond to text runs, paths, and images extracted from the fixed format document.

13. The system of claim 10 characterized in that:
said plurality of layout analysis engines comprises:
a page properties detection engine operable to analyze page properties associated with said plurality of physical layout objects, said page properties detection engine dependent on said parsing engine;
a text box detection engine operable to detect text runs intersecting page margins in said plurality of physical layout objects, said text box detection engine dependent on said parsing engine;
a pattern matching engine operable detecting similar elements appearing on at least two pages in the fixed format document, said pattern matching engine dependent on said parsing engine;
a formula detection engine operable to detect formulas, said formula detection engine dependent on said pattern matching engine;
an underline/strikethrough engine operable to detect underline and strikethrough text formatting, said underline/strikethrough engine dependent on said formula detection engine;
a table detection engine operable to detect tables having borders, said table detection engine dependent on said underline/strikethrough engine;
a basic graphic aggregation engine operable to group related graphics, said basic graphic aggregation engine dependent on said table detection engine; and
a plurality of text analysis engines.

14. The system of claim 10 characterized in that said plurality of text analysis engines comprises:
a region detection engine operable to detect regions, said region detection engine dependent on said vector graphic classification engine and said text run sorting engine;
a borderless table detection engine operable to detect tables without visible borders, said borderless table detection engine dependent on said region detection engine;
a page column detection engine operable to detect columns, said page column detection engine dependent on said borderless table detection engine;
a line detection engine operable to detect lines of text runs, said line detection engine dependent on said region detection engine;
a words-per-line detection engine operable to detect words associated with lines, said words-per-line detection engine dependent on said line detection engine;
an in-region paragraph detection engine operable to detect paragraphs occurring in a single region or page, said in-region paragraph detection engine dependent on said page column detection engine and said line detection engine; and
a page margin detection engine operable to calculate page margins, said page margin detection engine dependent on said in-region paragraph detection engine.

15. The system of claim 10 characterized in that said plurality of semantic analysis engines comprises:
a cross-region paragraph reconstruction engine operable to reconstruct paragraphs spanning more than one region or page in said logical layout objects, said cross-region paragraph reconstruction engine dependent on said page margin detection engine;
a footnote/endnote detection engine operable to reconstruct footnotes and endnotes in said logical layout objects, said footnote/endnote detection engine dependent on one of said in-region paragraph detection engine and said page margin detection engine;
a section reconstruction engine operable to create section objects in said logical layout objects, said section reconstruction engine dependent on said page margin detection engine;
a style reconstruction engine operable to reconstruct styles in said logical layout objects, said style reconstruction engine dependent on said section reconstruction engine;
a heading reconstruction engine operable to reconstruct headings in said logical layout objects, said heading reconstruction engine dependent on said style reconstruction engine; and
a table of contents reconstruction engine operable to reconstruct reference tables in said logical layout objects, said table of contents reconstruction engine dependent on said heading reconstruction engine;
a list reconstruction engine operable to reconstruct bulleted and/or numbered lists, said list reconstruction engine dependent on said heading reconstruction engine.

16. The system of claim 10 characterized in that said fixed format document conversion engine is operable to execute each of said plurality of layout analysis engines and said plurality of semantic analysis engines in a sequence based on dependencies between said plurality of layout analysis engines and said plurality of semantic analysis engines.

17. The system of claim 10 characterized in that said fixed format document conversion engine is operable to:
arrange said plurality of physical layout objects in a tree-like array of nodes with page nodes being a top level said physical layout object; and
arrange said plurality of logical layout objects in a tree-like array of nodes with section nodes being a top level said physical layout object.

18. A computer readable medium containing computer executable instructions which, when executed by a computer, perform a method for converting a fixed format document into a flow format document, said method comprising the steps of:
storing information extracted from a fixed format document as physical layout objects, said physical layout objects arranged hierarchically based on physical relationships between said physical layout objects;
enriching said physical layout objects using a selected sequence of layout analysis operations to analyze the physical layout of the fixed format document wherein said selected sequence of layout analysis operations is based on dependence on a results from at least one prior said layout analysis operation, said sequence of layout analysis operations comprising the steps of:
detecting whitespace in the fixed format document;
detecting shading in the fixed format document after said step of detecting whitespace;
detecting underline and strikethrough in the fixed format document after said step of detecting shading;
detecting boxes in the fixed format document after said step of detecting underline and striketh rough;
detecting tables in the fixed format document after said step of detecting boxes;
aggregating basic graphics in the fixed format document after said step of detecting tables;
detecting whitespace in the fixed format document after said step of aggregating basic graphics;
detecting regions in the fixed format document after said step of detecting whitespace;
detecting page columns in the fixed format document after said step of detecting regions;
detecting lines in the fixed format document after said step of detecting page columns;
detecting words per line in the fixed format document after said step of detecting lines;
detecting words per line in the fixed format document after said step of detecting lines;
expanding basic graphic aggregations in the fixed format document after said step of detecting words per line;
post-processing regions in the fixed format document after said step of expanding basic graphic aggregations;
detecting subscripts and superscripts in the fixed format document after said step of post-processing regions;
detecting borderless tables in the fixed format document after said step of post-processing regions;
detecting paragraphs appearing in a single region or page in the fixed format document after said step of post-processing regions;
detecting footnotes and endnotes in the fixed format document after said step of detecting paragraphs;
detecting page margins in the fixed format document after said step of detecting paragraphs; and
enriching logical layout objects using a selected sequence of semantic analysis operations to analyze the physical layout of the fixed format document wherein said sequence of semantic analysis operations is based on dependence on a results from at least one prior said semantic analysis operation or said layout analysis operation, said sequence of semantic analysis operations comprising the steps of:
reconstructing paragraphs spanning more than one said physical layout object;
reconstructing sections after said step of reconstructing paragraphs;
reconstructing headings after said step of reconstructing sections;
reconstructing text formatting styles after said step of reconstructing headings;
reconstructing tables of contents after said step of reconstructing text formatting styles; and
reconstructing bulleted and/or numbered lists after said step of reconstructing tables of contents.

19. The computer readable medium of claim 18 characterized in that said method further comprises the step of serializing said logical layout objects to create a flow format document corresponding to the fixed format document using said plurality of said logical layout objects and said plurality of physical layout objects.

20. The computer readable medium of claim 18 characterized in that said physical layout objects correspond to text runs, paths, and images extracted from the fixed format document.
